(19) United States
(12) Patent Application Publication
(10) Pub. No.: US 2020/0387980 A1
(43) Pub. Date: Dec. 10, 2020

(54) AUTOMATED MECHANISM TO REGULATE MEMBERSHIP IN EXPERT GROUP SYSTEM

(71) Applicant: SAP SE, Walldorf (DE)

(72) Inventor: Takvor Tilkiyan, Haskovo (BG)

(21) Appl. No.: 16/433,094

(22) Filed: Jun. 6, 2019

(51) Int. Cl. G06Q 50/00; G06F 16/953; G09B 7/00

(52) U.S. Cl. CPC G06Q 50/01; G09B 7/00; G06F 16/953

(57) ABSTRACT

According to some embodiments, regulation of membership in an expert system may be facilitated via an expert group system platform with a dispatch engine that receives user query messages from remote user devices. Responsive to receipt of the user query messages, the dispatch engine may automatically exchange information with remote expert devices and, based on data received from the remote expert devices, automatically transmit response messages to the remote user devices via the dispatch engine. An evaluation engine may select a remote expert device for evaluation and transmit a test query message to the remote expert device being evaluated. The evaluation engine may also automatically calculate a score for a response message received from the remote expert device being evaluated. A membership rule may then be applied by the evaluation engine in connection with the remote expert device based on the automatically calculated score.

### FIELD

Some embodiments relate to systems and methods for expert group systems. More specifically, some embodiments comprise systems and methods to automatically facilitate membership regulation for an expert group system.

### BACKGROUND

An expert group system may help users find relevant answers to their questions or queries. For example, software experts may respond to users who have questions about coding syntax, protocol, best practices, etc. Such expert group systems may maintain a database of experts who can be contacted for help. Over time, however, these databases may become full of experts who are no longer as good as they used to be or are no longer willing to share their expertise. When users request help from these experts in the group, the experts may be unable to help—because they are not up-to-date about the latest development in their field. In some cases, an expert might not respond at all—because they are no longer interested in helping others. Such situations may frustrate and discourage users of the expert group system.

Accordingly, methods and mechanisms to efficiently, accurately, and/or automatically manage messaging between an expert group system and remote expert devices to regulate membership may be provided in accordance with some embodiments described herein.

### SUMMARY

Some embodiments provide a system, method, program code, and/or means to manage messaging between an expert group system and remote expert devices to regulate membership. According to some embodiments, regulation of membership in an expert system may be facilitated via an expert group system platform with a dispatch engine that receives user query messages from remote user devices. Responsive to receipt of the user query messages, the dispatch engine may automatically exchange information with remote expert devices and, based on data received from the remote expert devices, automatically transmit response messages to the remote user devices via the dispatch engine. An evaluation engine may select a remote expert device for evaluation and transmit a test query message to the remote expert device being evaluated. The evaluation engine may also automatically calculate a score for a response message received from the remote expert device being evaluated. A membership rule may then be applied by the evaluation engine in connection with the remote expert device based on the automatically calculated score.

Some embodiments comprise: means for receiving, by a computer processor of expert group system platform dispatch engine, user query messages from remote user devices; responsive to receipt of the user query messages, means for automatically exchanging information with remote expert devices via the dispatch engine; based on data received from the remote expert devices, means for automatically transmitting response messages to the remote user devices via the dispatch engine; means for selecting, by an evaluation engine of the expert group system platform, a remote expert device for evaluation; means for transmitting a test query message from the evaluation engine to the remote expert device being evaluated; means for automatically calculating, by the evaluation engine, a score for a response message received from the remote expert device being evaluated; and means for applying a membership rule in connection with the remote expert device based on the automatically calculated score.

With these and other advantages and features that will become hereinafter apparent, further information may be obtained by reference to the following detailed description and appended claims, and to the figures attached hereto.

### BRIEF DESCRIPTION OF THE DRAWINGS

FIG. 1 is a block diagram of a system architecture according to some embodiments.

FIG. 2 is a flow diagram of a process in accordance with some embodiments.

FIG. 3 is an example of a mobile user device displaying information according to some embodiments.

FIG. 4 is a block diagram of a system in accordance with some embodiments.

FIG. 5 is an example of an expert evaluation display according to some embodiments.

FIG. 6 is a more detailed block diagram of a system architecture according to some embodiments.

FIG. 7 is an example of expert evaluation according to some embodiments.

FIG. 8 is a block diagram of an apparatus according to some embodiments.

FIG. 9 illustrates a portion of an expert membership evaluation database that might be stored in accordance with some embodiments.

FIG. 10 is a flow diagram of an expert evaluation process in accordance with some embodiments.

FIG. 11 is a diagram of a system architecture according to some embodiments.

### DETAILED DESCRIPTION

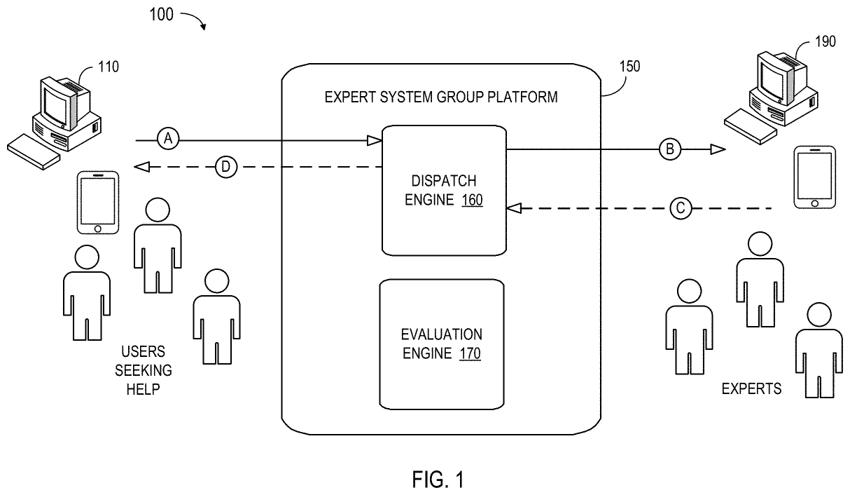

FIG. 1 is a block diagram of a system 100 according to some embodiments. The system 100 includes mobile user devices 110 that can exchange information, such questions or queries looking for help from one or more experts. The mobile user devices 110 might be associated with, by ways of example only, a mobile computer, a smartphone, a gaming device, a navigation device, a music player, or glasses having a lens-based display.

The mobile user devices 110 may exchange information with an expert system group platform 150. By way of example only, the expert system group platform 150 might be associated with an Enterprise Resource Planning (“ERP”) server, a business services gateway, a HyperText Transfer Protocol (“HTTP”) server, and/or an Advanced Business Application Programming (“ABAP”) server.

According to some embodiments, the expert system group platform 150 may directly communicate with one or more remote mobile user devices 110 via the Internet. According to other embodiments, a gateway may be provided between the expert system group platform 150 and the mobile user devices 110. The mobile user devices 110 may include one or more processors to receive electronic files and/or to execute applications and/or components (e.g., a plug-in that is integrated within a smartphone).

Note that FIG. 1 represents a logical architecture for the system 100 according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the expert system group platform 150 and mobile user device 110, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

All systems and processes discussed herein may be embodied in program code stored on one or more computer-readable media. Such media may include, for example, a floppy disk, a CD-ROM, a DVD-ROM, magnetic tape, or solid state Random Access Memory (“RAM”) or Read Only Memory (“ROM”) storage units. Embodiments are therefore not limited to any specific combination of hardware and software.

At (A), a user device 110 may transmit a query message to the expert system group platform 150. A dispatch engine 160 may then automatically transmit information to remote expert devices 190 at (B) and receive data from the remote expert devices 190 at (C). The data received from the remote expert devices 190 may represent, for example, an answer to the user's query. The dispatch engine 160 may then provide the answer to the remote user device 110 at (D).

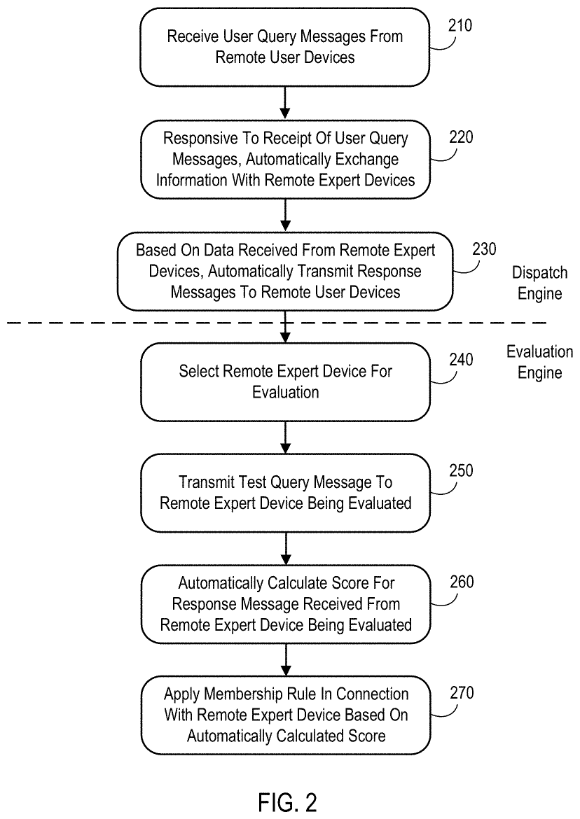

According to some embodiments, an evaluation engine 170 may help ensure that only qualified and interested experts remain in the system 100. For example, FIG. 2 is a flow diagram of a process 200 that might be associated with the illustration of the system 100 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At 210, a computer processor of an expert group system platform dispatch engine may receive a user query messages from remote user devices. Responsive to receipt of the user query messages, at 220 the system may automatically exchange information with remote expert devices via the dispatch engine. Note that the remote user devices and/or remote expert devices might be associated with, for example, a Personal Computer (“PC”), a smartphone, a tablet computer, a workstation, a set-top television device, a gaming device, etc. Based on data received from the remote expert devices, the system may then automatically transmit response messages to the remote user devices via the dispatch engine at 230.

For example, the dispatch engine may receive a first user query message from a first user via a first remote user device and, responsive to the first user query message, transmit a first expert query message to a first expert via a first remote user device. The dispatch engine may further receive a first expert response message from the first expert via the first remote expert device and, responsive to the first expert response message, transmit a first user response message to the first user via the first remote user device.

The system may also facilitate expert membership regulation to help make sure that only highly qualified, responsive experts remain in the system. For example, at 240 an evaluation engine of the expert group system platform may select a remote expert device for evaluation. The evaluation engine may select the remote expert device to be evaluated based on, for example, a pre-determined period of time (e.g., it has been one year since that expert was evaluated), a period of inactivity (e.g., that expert has not answered any user questions during the past 30 days), a pre-determined number of query or response messages (e.g., that expert has answered twenty questions since the last evaluation, a score of a prior response message (e.g., the system has determined that one or more prior answers from that expert might not be accurate), a user or expert rating (e.g., via social media), etc.

At 250, a test query message may be transmitted from the evaluation engine to the remote expert device that is being evaluated. The test query message may include, according to some embodiments, at least one prior user query message submitted in connection with another expert. Note that the test query message might include a plurality of prior user query messages submitted in connection with other experts.

At 260, the evaluation engine may automatically calculate a score for a response message received from the remote expert device being evaluated. The automatically calculated score might include, according to some embodiments, a comparison of a response message from the expert device being evaluated with at least one prior expert response message received from with another expert. Moreover, the automatically calculated score may include a comparison of the response message from the expert device being evaluated with a plurality of expert response messages received from other experts. According to some embodiments, the evaluation engine selects the at least one prior user query message in the test query message based on information about the remote expert device being evaluated (e.g., the questions might pertain to a subject area where the expert has had trouble providing accurate answers in the past). Note that the automatically calculated score might be associated with an Artificial Intelligence (“AI”) process, Machine Learning (“ML”), a text mining function, a Bi-directional Encoder Representation from Transformers (“BERT”) process, etc.

At 270, a membership rule may be applied in connection with the remote expert device based on the automatically calculated score. The membership rule might comprise, for example, revoking the expert's membership in the expert system if no expert response message is received from the remote expert device being evaluated (e.g., the expert ignored the test query message). As another example, the membership rule might comprise, when the automatically calculated score is below a pre-determined threshold value, revoking the expert's membership in the expert system or suspending the expert's membership in the expert system (e.g., for thirty days).

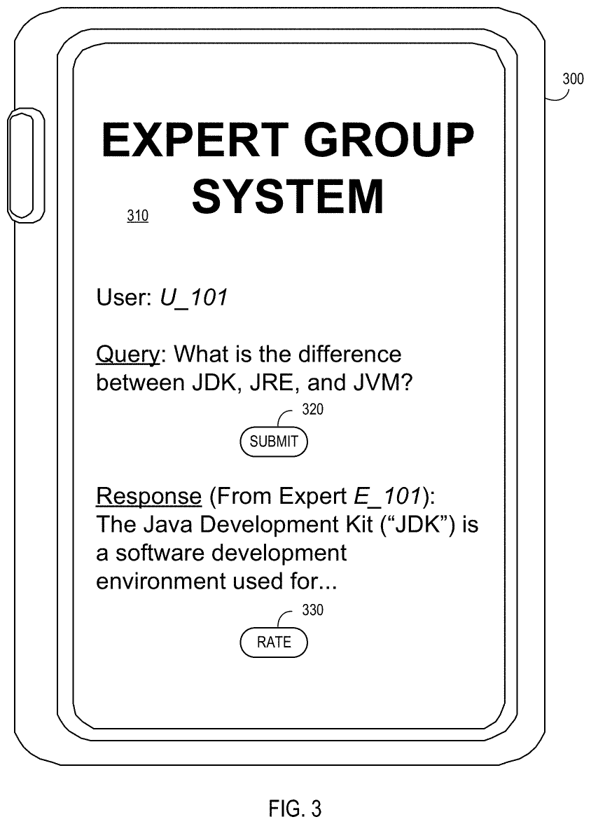

FIG. 3 is an example of a mobile user device 300 displaying information to a user seeking help from experts according to some embodiments. A display 310 may include a user identifier (e.g., “U_101”), a user query that may be transmitted via a “Submit” icon 320, and a response from an expert. The user may then use a “Rate” icon 330 to evaluate the helpfulness of the expert's response.

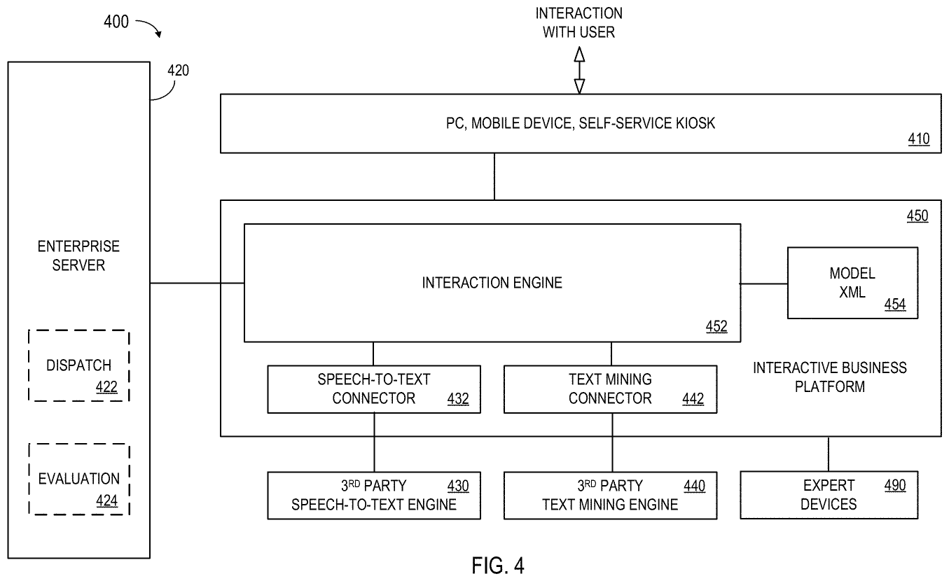

FIG. 4 is a block diagram of a system 400 in accordance with some embodiments. The system 400 includes a device 410, such as a PC, mobile device, or self-service kiosk, that facilitates interactions between a user and a remote enterprise server 420 (including a dispatch component 422 and an evaluation component 424 in accordance with any of the embodiments described herein. In particular, an interactive business platform 450 may communicate with both the user device 410, the enterprise server 420, and expert devices 490. The interactive business platform 450 includes an interaction engine 452 that executes a model XML 454 to operate in accordance with any of the embodiments described herein. The interaction engine 452 may also communicate with a third-party speech-to-text engine 430 via a speech-to-text connector 432 and with a third-party text mining engine 440 via a text mining connector 442. In this way, a designer may generate simple XML code to implement enterprise server 420 functions (letting 3^{rd} parties handle the complex speech/text conversion and mining tasks).

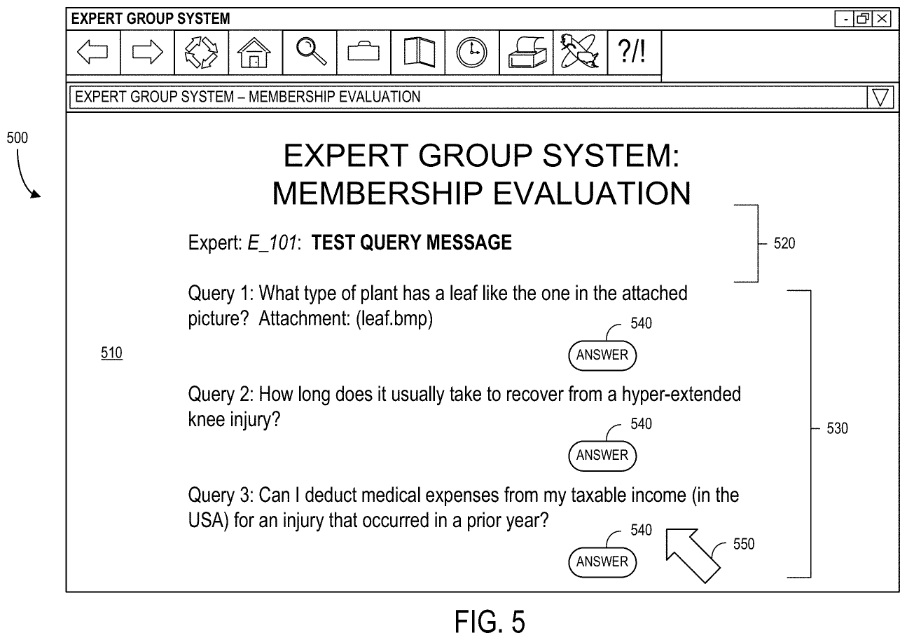

FIG. 5 is an example of a display 500 that might be shown to an expert according to some embodiments. In this case, the display 500 includes expert group system membership evaluation information 510 containing a test query message 520 for a particular expert (e.g., expert “E_101”). The test query message 520 is composed of three individual questions 530. The expert may provide responses to the questions via “Answer” icons 540 (e.g., selected via a touchscreen or computer mouse pointer 550).

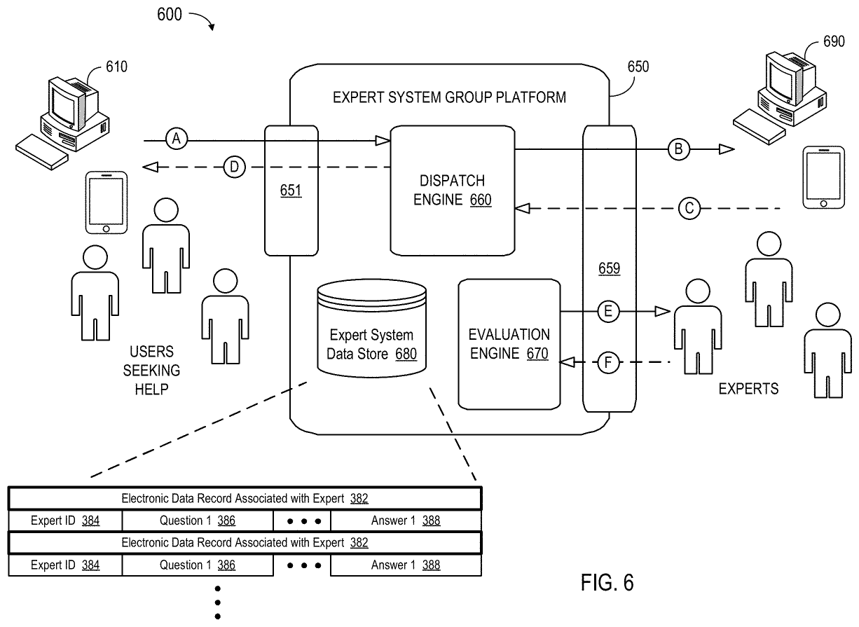

FIG. 6 is a more detailed block diagram of a system architecture according to some embodiments. As before, the system 600 includes mobile user devices 610 that can exchange information, such questions or queries looking for help from one or more experts. The mobile user devices 610 may exchange information with an expert system group platform 650. At (A), a user device 610 may transmit a query message to the expert system group platform 650 via a communication port 651. A dispatch engine 660 may then automatically transmit information via a communication port 659 to remote expert devices 690 at (B) and receive data from the remote expert devices 690 at (C). The data received from the remote expert devices 690 may represent, for example, an answer to the user's query. The dispatch engine 660 may then provide the answer to the remote user device 610 at (D). The messages representing the user questions and expert answers may be stored in an expert system data store 680 (e.g., as a series of electronic data records 382 including an expert identifier 384, questions 386, answers 388, etc.).

An evaluation engine 670 of the expert system group platform 650 may then use the stored questions to create a test query message that is transmitted to an expert being evaluated at (E). At (F), the expert answers the test query message and the evaluation engine 670 may use the answers stored in the expert system data store 680 to automatically calculate a score for the expert being evaluated. This score may then be used to revoke an expert's membership, impose a suspension, promote the expert to “verified” status, etc. as appropriate.

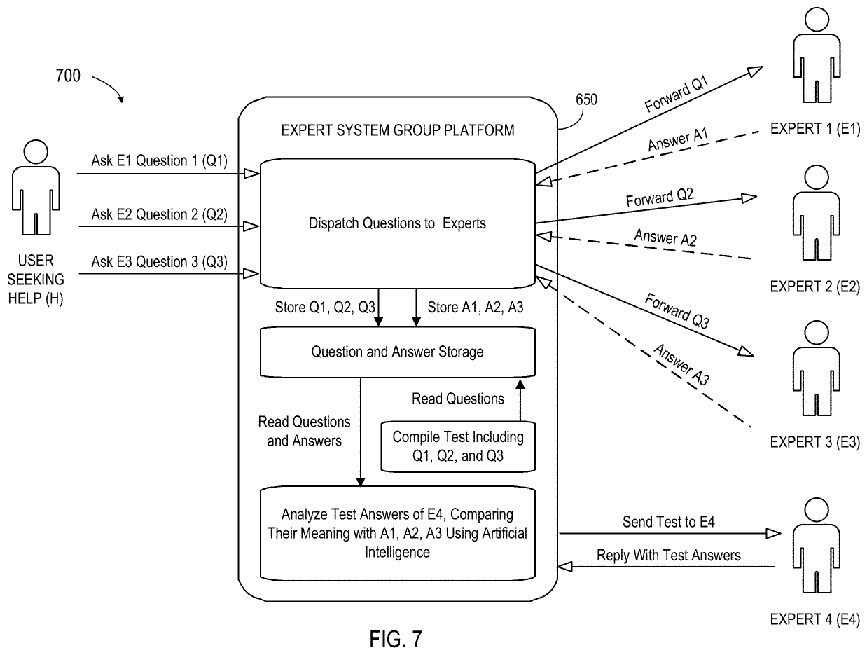

FIG. 7 is an example 700 of expert evaluation according to some embodiments. Here, a user seeking help (“H”) transmits three questions (“Q1,” “Q2,” and “Q3”) to an expert system group platform 650. These questions are dispatched to three experts (“E1,” “E2,” and “E3”) who provide answers (“A1,” “A2,” and “A3”). Q1-Q3 and A1-A3 are stored and used to compile a test containing Q1, Q2, and Q3 to evaluate an expert “E4.” The system may then analyze a reply from E4 with test answers based on the stored A1-A3 using A1.

In this way, an automated mechanism for regulating membership in an expert group system may regularly check the level of expertise and responsiveness of the experts in the group. For example, every 6 months (or any other period) the system may automatically send a short test, consisting of a few expertise-related questions, to each expert and expect a response from the expert. If the expert does not reply, the expert may be removed from the group. If the expert responds correctly, the expert may remain in the group. If the expert responds incorrectly, the expert may be removed or suspended from the group.

The questions in the test may be taken from questions that have been already asked to other experts by help seekers through the system. For example, when a help seeker H uses the expert group system to ask question Q1 to expert E1, question Q2 to expert E2, and question Q3 to expert E3, the automated mechanism for regulating the membership in the group might compile a test for expert E4 consisting of questions Q1, Q2, and Q3. When expert E4 responds, the answers of E4 will be compared to the answers given by E1, E2, and E3. This comparison may be automatic, leveraging AI, ML and Natural Language Processing (“NLP”) for text similarity when comparing of the answers of E4 and the answers of E1, E2, and E3. To perform such a text similarity comparison, various text mining functions and BERT language models may be employed.

According to some embodiments, a text mining functions may utilize a “bag of words” model to represent terms in text as a list of vectors, keeping multiplicity of words. Two texts, or in this case two expert answers (e.g., the answer of E4 and answer of E1) may be regarded similar based on the relative weights of the terms in them. The measures used for similarity might include COSINE, JACCARD, DICE, OVERLAP, etc. Note that text mining functions may compare expert answers by examining the terms used in them. With the BERT language model for NLP, each word in the text, or in this case an expert answer (e.g., answer of E4) may be represented with consideration of all the other words in its sentence. Using next sentence prediction, BERT may understand semantic information in sentences and this in turn may be used to compare expert answers—e.g., the answer of E4 to the answers of E1, E2, E3. Another set of techniques that BERT may use to determine text similarity is sentence embedding (where sentences are mapped to vectors).

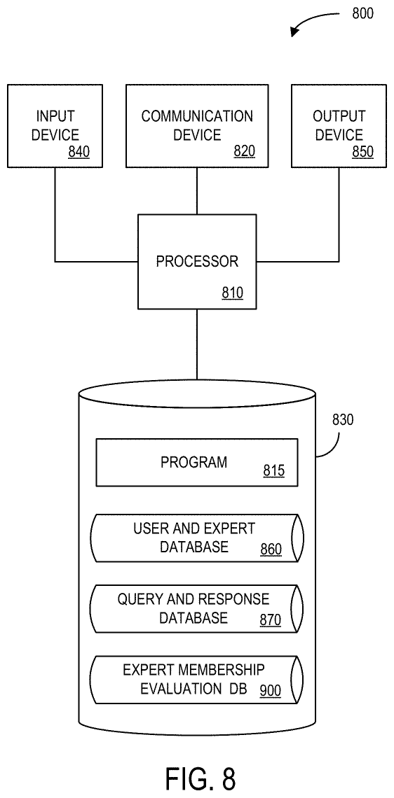

FIG. 8 is a block diagram overview of an apparatus 800 according to some embodiments. The apparatus 800 may be, for example, associated with an expert system group platform. The apparatus 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used, for example, as port to exchange information with remote user and expert devices. The apparatus 800 further includes an input device 840 (e.g., a keyboard to receive information about expert membership rules) and an output device 850 (e.g., to create reports, alerts when expert memberships are revokes, etc.).

The processor 810 communicates with a storage device 830. The storage device 830 may comprise any appropriate information storage device, including combinations of magnetic storage devices (e.g., a hard disk drive), optical storage devices, and/or semiconductor memory devices. The storage device 830 stores a program 815 for controlling the processor 810. The processor 810 performs instructions of the program 815 and thereby operates in accordance with any of the embodiments described herein. For example, the processor 810 may regulate membership in an expert system by receiving user query messages from remote user devices. Responsive to receipt of the user query messages, the processor 810 may automatically exchange information with remote expert devices and, based on data received from the remote expert devices, automatically transmit response messages to the remote user devices via the dispatch engine. The processor 810 may also select a remote expert device for evaluation and transmit a test query message to the remote expert device being evaluated. The processor 810 may then automatically calculate a score for a response message received from the remote expert device being evaluated. A membership rule may be applied by the processor 810 in connection with the remote expert device based on the automatically calculated score.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the apparatus 800 from another device; or (ii) a software application or module within the apparatus 800 from another software application, module, or any other source.

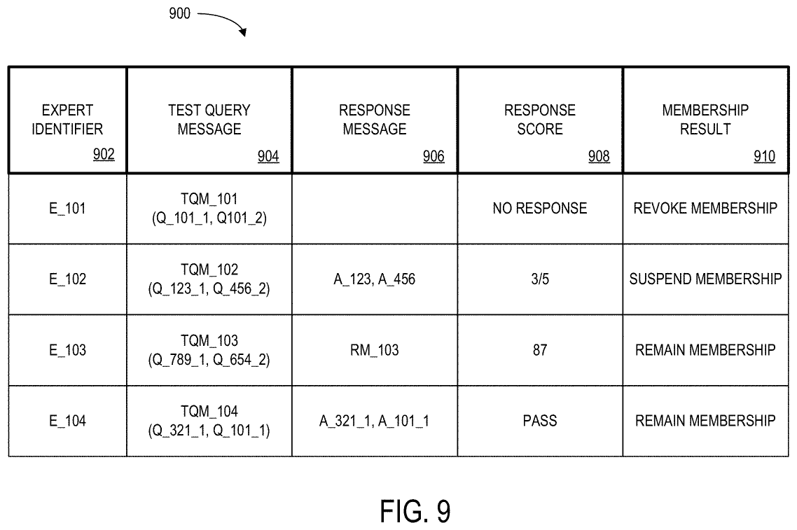

In some embodiments (such as shown in FIG. 8), the storage device 830 further stores a user and expert database 860, a query and response database 870, and an expert membership evaluation database 900 (e.g., including information about interactions between users and experts). An example of a database that may be used in connection with the apparatus 800 will now be described in detail with respect to FIG. 9. Note that the database described herein is only an example, and additional and/or different information may be stored therein. Moreover, various databases might be split or combined in accordance with any of the embodiments described herein.

Referring to FIG. 9, a table is shown that represents the expert membership evaluation database 900 that may be stored at the apparatus 800 according to some embodiments. The table may include, for example, entries identifying experts who have been (or are being) evaluated. The table may also define fields 902, 904, 906, 908, 910 for each of the entries. The fields 902, 904, 906, 908, 910 may, according to some embodiments, specify: an expert identifier 902, a test query message 904, a response message 906, a response score 908, and a membership result. The information in the map database 900 may be created and updated, for example, based on interactions between an expert group system platform and remote expert devices.

The expert identifier 902 may be, for example, a unique alphanumeric code identifying a particular subject matter expert (e.g., a tax accountant, scientist, software engineer, etc.). The test query message 904 may contain (or point to) test questions that are based on prior user queries, public information (e.g., from Wikipedia), etc. The response message 906 may reflect the answer that the expert provided in connection with the test query message 904. The response score 908 might be automatically calculated based on answers from other experts using NLP, ML, AI, etc. The membership result 910 might indicate that the expert's membership should be revoked, suspended, etc.

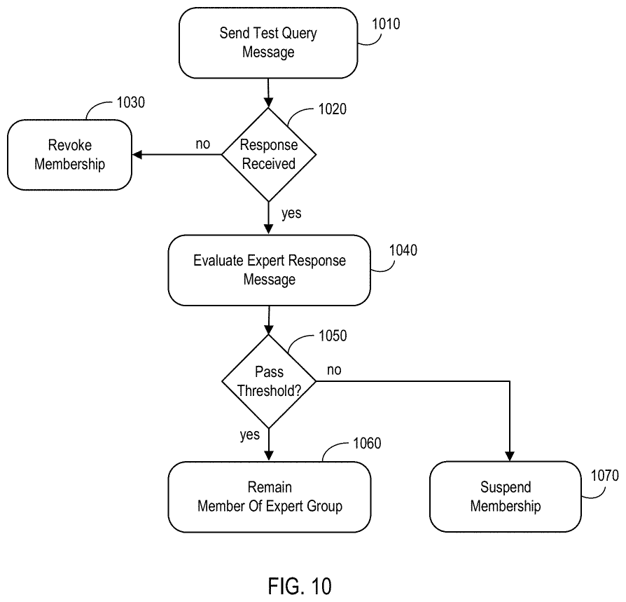

Note that various membership rules may be applied to an expert group. For example, FIG. 10 is a flow diagram of an expert evaluation process in accordance with some embodiments. At 1010, a test query message to sent to an expert being evaluated (e.g., containing questions previously asked by users and answered by other experts). If no response is received at 1020, the expert's membership may be revoked at 1030.

If a response is received at 1020, the expert's response message is evaluated at 1040. For example, the expert's response message may be compared to answers to the same questions that were provided by other qualified experts. If the evaluation fails to pass a minimum threshold at 1050, the expert's membership is suspended at 1070 (e.g., he or she may receive a one-week suspension). If the evaluation passes the minimum threshold at 1050, the expert remains a member of the expert group at 1060

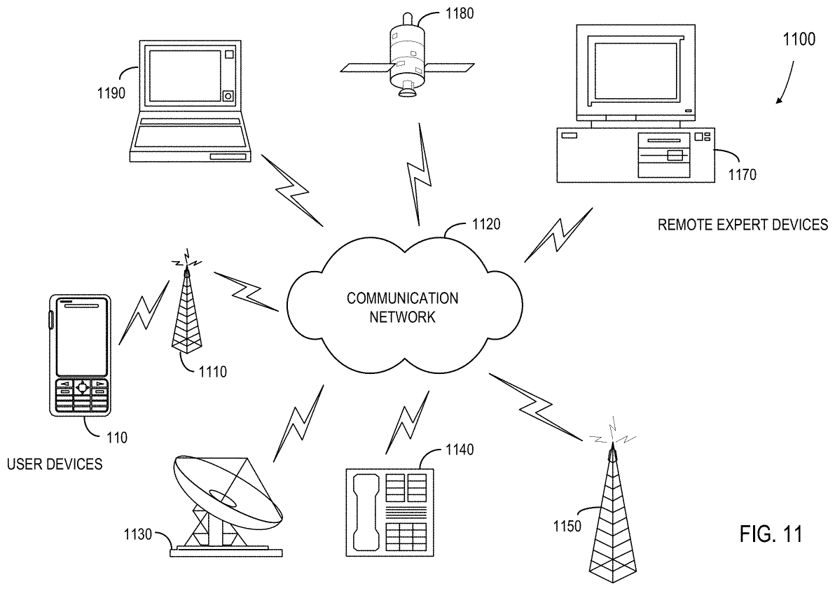

FIG. 11 is a partial diagram of a communication architecture 1100 according to some embodiments. In particular, a mobile communication device 110 (in this example, a smartphone of a user seeking expert help) is shown in communication with tower 1110, which may forward the transmission to communication network 1120 according to governing protocols. Communication network 1120 may include any number of devices and systems for transferring data, including but not limited to local area networks, wide area networks, telephone networks, cellular networks, fiber-optic networks, satellite networks, infra-red networks, radio frequency networks, and any other type of networks which may be used to transmit information between devices. Additionally, data may be transmitted through communication network 1120 using one or more currently- or hereafter-known network protocols, including but not limited to ATM, IP, HTTP, and WAP.

Devices 1130 through 1190 are examples of some devices that may be a part of or in communication with communication network 1120. As such, devices 1130 through 1190 may receive communication events, either as intended recipients or as network nodes for passing messages. Devices 1130 through 1190 include satellite transmitter/receiver 1130, landline telephone 1140 having a subscriber line interface circuit to receive a telephone line (e.g., a cordless phone or a corded phone), communication tower 1150, desktop computer or server 1170, satellite 1180 and portable computing device 1190 (e.g. associated with an expert). Note the server 1170 might be associated with, for example, a remote database containing CRM information (e.g., to facilitate expert assistance through the mobile communication device 110). Any other suitable devices may be used as a transmitting device or a receiving device in conjunction with some embodiments.

The elements of system 1100 may be connected differently than as shown. For example, some or all of the elements may be connected directly to one another. Embodiments may include elements that are different from those shown. Moreover, although the illustrated communication links between the elements of system 1100 appear dedicated, each of the links may be shared by other elements. Elements shown and described as coupled or in communication with each other need not be constantly exchanging data. Rather, communication may be established when necessary and severed at other times or always available but rarely used to transmit data. According to some embodiments, interactions between a user, a business application executing at the server 1170, and/or an expert may be facilitated via an expert group system platform executing on demand in a computing cloud environment (located with or accessed via the communication network 1120).

The system 1100 may use one or more models to facilitate expert assistant via handheld or any other devices. Such models may be created, for example, by a model designer or architect via a platform that creates and extends applications for enterprise voice interaction scenarios. Designers may be able to define a model (represented in a specified XML schema) that represents interaction between a set of users and a set of experts. The platform may be pluggable and provide an ability to add new models which will describe new interactions without any coding.

Thus, some embodiments may provide a mechanism to regulate membership in an expert group system along with an automated procedure that scales over a large number of members. Embodiments may also become more accurate over time as ML is leveraged (such that the system may select the best test questions for specific experts). Moreover, when evaluating test answers, A1 may provide an objective quantitative measure of the expert's competency (which will be fair for all experts).

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to business systems and databases, note that embodiments may be associated with other types of enterprise data. For example, financial, governmental, educational, legal, and/or medical expert group systems may be facilitated in accordance with any of the embodiments described herein. Moreover, while embodiments have been illustrated using particular types of tables and databases, embodiments may be implemented in any other of a number of different ways. For example, some embodiments might be associated with third-party and/or publicly available information, such as textbooks or educational websites. Further, while examples have been provided in a single language, note that any embodiment may be associated with language translation tools (e.g., to convert Spanish to English). Still further, embodiments may support operation to evaluate automated experts (e.g., subject matter “bots”) in addition to human experts.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A system to regulate membership in an expert system, comprising:
a user communication port to exchange information with remote user devices;
an expert communication port to exchange information with remote expert devices; and
an expert group system platform, coupled to the user communication port and the expert communication port, including:
a memory unit storing computer executable instructions, and
a processor to execute the instructions in the memory unit resulting in the processor performing the following steps:
(i) receive, by a dispatch engine, user query messages from the remote user devices,
(ii) responsive to receipt of the user query messages, automatically exchange information with the remote expert devices via the dispatch engine,
(iii) based on data received from the remote expert devices, automatically transmit response messages to the remote user devices via the dispatch engine,
(iv) select, by an evaluation engine, a remote expert device for evaluation,
(v) transmit a test query message from the evaluation engine to the remote expert device being evaluated,
(vi) automatically calculate, by the evaluation engine, a score for a response message received from the remote expert device being evaluated, and
(vii) apply a membership rule in connection with the remote expert device based on the automatically calculated score.

2. The system of claim 1, wherein at least one remote user device or remote expert device is associated with at least one of: (i) a personal computer, (ii) a smartphone, (iii) a tablet computer, (iv) a workstation, (v) a set-top television device, and (vi) a gaming device.

3. The system of claim 1, wherein the dispatch engine receives a first user query message from a first user via a first remote user device and, responsive to the first user query message, transmits a first expert query message to a first expert via a first remote user device.

4. The system of claim 3, wherein the dispatch engine further receives a first expert response message from the first expert via the first remote expert device and, responsive to the first expert response message, transmits a first user response message to the first user via the first remote user device.

5. The system of claim 1, wherein the evaluation engine selects the remote expert device to be evaluated based on at least one of: (i) a pre-determined period of time, (ii) a period of inactivity, (iii) a pre-determined number of query or response messages, (iv) a score of a prior response message, and (v) a user or expert rating.

6. The system of claim 1, wherein the test query message includes at least one prior user query message submitted in connection with another expert.

7. The system of claim 6, wherein the test query message includes a plurality of prior user query messages submitted in connection with other experts.

8. The system of claim 6, wherein the automatically calculated score includes a comparison of a response message from the expert device being evaluated with at least one prior expert response message received from with another expert.

9. The system of claim 8, wherein the automatically calculated score includes a comparison of the response message from the expert device being evaluated with a plurality of expert response messages received from other experts.

10. The system of claim 6, wherein the evaluation engine is further to select the at least one prior user query message in the test query message based on information about the remote expert device being evaluated.

11. The system of claim 6, wherein the automatically calculated score is associated with at least one of: (i) an artificial intelligence process, (ii) machine learning, (iii) a text mining function, and (iv) a bi-directional encoder representation from transformers process.

12. The system of claim 6, wherein the membership rule comprises revoking the expert's membership in the expert system if no expert response message is received from the remote expert device being evaluated.

13. The system of claim 12, wherein the membership rule comprises, when the automatically calculated score is below a pre-determined threshold value, performing one of: (i) revoking the expert's membership in the expert system, and (ii) suspending the expert's membership in the expert system.

14. A computer-implemented method to regulate membership in an expert system, comprising:
receiving, by a computer processor of expert group system platform dispatch engine, user query messages from remote user devices;
responsive to receipt of the user query messages, automatically exchanging information with remote expert devices via the dispatch engine;
based on data received from the remote expert devices, automatically transmitting response messages to the remote user devices via the dispatch engine;
selecting, by an evaluation engine of the expert group system platform, a remote expert device for evaluation;
transmitting a test query message from the evaluation engine to the remote expert device being evaluated;
automatically calculating, by the evaluation engine, a score for a response message received from the remote expert device being evaluated; and
applying a membership rule in connection with the remote expert device based on the automatically calculated score.

15. The method of claim 14, wherein at least one remote user device or remote expert device is associated with at least one of: (i) a personal computer, (ii) a smartphone, (iii) a tablet computer, (iv) a workstation, (v) a set-top television device, and (vi) a gaming device.

16. The method of claim 14, wherein the dispatch engine receives a first user query message from a first user via a first remote user device and, responsive to the first user query message, transmits a first expert query message to a first expert via a first remote user device.

17. The method of claim 16, wherein the dispatch engine further receives a first expert response message from the first expert via the first remote expert device and, responsive to the first expert response message, transmits a first user response message to the first user via the first remote user device.

18. A non-transitory, computer-readable medium storing program code executable by a computer processor to perform a method to regulate membership in an expert system, the method comprising:
receiving, by a computer processor of expert group system platform dispatch engine, user query messages from remote user devices;
responsive to receipt of the user query messages, automatically exchanging information with remote expert devices via the dispatch engine;
based on data received from the remote expert devices, automatically transmitting response messages to the remote user devices via the dispatch engine;
selecting, by an evaluation engine of the expert group system platform, a remote expert device for evaluation;
transmitting a test query message from the evaluation engine to the remote expert device being evaluated;
automatically calculating, by the evaluation engine, a score for a response message received from the remote expert device being evaluated; and
applying a membership rule in connection with the remote expert device based on the automatically calculated score.

19. The medium of claim 18, wherein the test query message includes a plurality of prior user query messages submitted in connection with other experts.

20. The medium of claim 19, wherein the automatically calculated score includes a comparison of the response message from the expert device being evaluated with a plurality of expert response messages received from other experts.

21. The medium of claim 18, wherein the membership rule comprises:
revoking the expert's membership in the expert system if no expert response message is received from the remote expert device being evaluated, and
when the automatically calculated score is below a pre-determined threshold value, performing one of: (i) revoking the expert's membership in the expert system, and (ii) suspending the expert's membership in the expert system.
